(19) United States
(12) Patent Application Publication
(10) Pub. No.: US 2013/0249967 A1
(43) Pub. Date: Sep. 26, 2013

(54) BACKLIGHT COMPENSATION PATTERN

(71) Applicant: Christophe Bernard, London (GB)

(72) Inventor: Christophe Bernard, London (GB)

(73) Assignee: ZORAN (FRANCE) S.A., Malakoff (FR)

(21) Appl. No.: 13/990,355

(22) PCT Filed: Dec. 9, 2011
(86) PCT No.: PCT/EP2011/072280

§ 371 Date: May 29, 2013

Related U.S. Application Data
(60) Provisional application No. 61/422,288, filed on Dec. 13, 2010.

(51) Int. Cl. G09G 5/10

(52) U.S. Cl. CPC G09G 5/10
USPC 345/690; 315/297

(57) ABSTRACT

For estimating an illumination pattern generated by the plurality of light sources, a combination of contributions of the light sources is computed. The contribution of a light source comprises a combination of at least a first component, comprising a part of a reference profile aligned on a position of said light source, said part of the aligned reference profile extending within the illumination area, and a second component depending on a distance between the position of said light source and an edge of the illumination area.

The present invention relates to illumination technique in a display device including, but not limited to, a Liquid Crystal Display (LCD) panel.

### BACKGROUND OF THE INVENTION

A display panel can be part of a television set, a computer monitor or any object containing a display panel. A display panel is often illuminated with a plurality of light sources, typically Light-Emitting Diodes (LEDs) or LED groups disposed in or around an illumination area. These light sources can be arranged:
in a 2-dimensional grid to illuminate the display panel from its back in a so-called 2D backlight arrangement;
or along two opposite edges of the panel to illuminate the display panel laterally in a so-called edge dimming arrangement.

It is possible to prescribe different power values to each LED or LED group in order to modify the global illumination pattern provided in the illumination area and thus to darken some specific parts of the display panel. A side effect of this modification can be the reduction of the power consumption of the device.

The global illumination pattern of the display panel results from the set of power values that are prescribed to the LEDs or LED groups. This global illumination pattern is modulated spatially by an array of light modulators, typically liquid crystal modulators, arranged in front of the illumination area and controlled independently of each other according to an image signal.

The global illumination pattern may be adapted to the image displayed on the display panel to enhance the image quality. For this, it is helpful to determine the global illumination pattern based on the set of power values that are prescribed to each LED or LED group.

For instance, it is relevant to determine the global illumination if it is needed to darken a specific part of the display panel to improve the depth of the black color. The illumination pattern, i.e. the distribution of light intensity coming from the LED sources over the illumination area, must be known in order to adapt the control values for the light modulators (e.g. liquid crystals).

There is thus a need for a method to estimate efficiently an illumination pattern in a display panel with a good trade-off between speed of the estimation, accuracy, storage needed, and required processing power.

### SUMMARY OF THE INVENTION

A method of estimating an illumination pattern in a display device having a plurality of light sources arranged to illuminate an illumination area and an array of modulators distributed over the illumination area is disclosed. The light sources are driven by respective control signals to generate the illumination pattern. The modulators are arranged to control transmission of light received from the light sources to display an image.

The method comprises computing the illumination pattern generated by the plurality of light sources as a combination of contributions of the light sources. The contribution of a light source is proportional to a sum of at least:
a first component, comprising a part of a reference profile aligned on a position of said light source, said part being defined on the illumination area; and
a second component depending on a distance between the position of said light source and an edge of the illumination area.

In an embodiment, the second component is proportional to a mirror copy, with respect to said edge of the illumination area, of another part of the reference profile aligned on the position of said light source, said other part of the aligned reference profile extending beyond said edge of the illumination area.

The sum to which the contribution of a light source is proportional may include:
said first component;
said second component depending on the distance between the position of the light source and a first edge of the illumination area; and
a third component depending on a distance between the position of the light source and a second edge of the illumination area, opposite said first edge.

The contribution of each light source may also be slightly non linear.

The second component may then be proportional to a mirror copy, with respect to the first edge of the illumination area, of a second part of the reference profile aligned on the position of the light source, said second part of the aligned reference profile extending beyond the first edge of the illumination area. The third component may be proportional to a mirror copy, with respect to the second edge of the illumination area, of a third part of the reference profile aligned on the position of the light source, said third part of the aligned reference profile extending beyond the second edge of the illumination area.

In an alternative embodiment, the reference profile is periodic along at least one dimension of the illumination area, with a period twice larger than an extension of the illumination area along said dimension.

In such an embodiment, computing the illumination pattern generated by the plurality of light sources may comprise:
for each light source, shifting the periodic reference profile into alignment with said light source;
within a domain having an extension twice larger than the extension of the illumination area along said dimension, summing weighted values of the respective shifted reference profiles for the plurality of light sources to obtain an accumulated illumination profile defined in said domain; and
folding values of the accumulated illumination profile extending beyond an edge of the illumination area into the illumination area and, in the illumination area, adding the accumulated illumination profile and the folded accumulated illumination profile.

Wavelet coefficients may advantageously be stored to represent the reference profile. In a convenient embodiment, the wavelet coefficients are derived from the reference profile using symmetric or asymmetric wavelet filters.

For instance, the above derivation may comprise a truncation of the wavelet coefficients. Thus, the most insignificant coefficients may not be stored.

According to another feature, the illumination pattern is computed at a subsampled resolution with respect to a resolution of the modulator array. The illumination pattern may be computed at the subsampled resolution according to a grid having U+1 columns and V+1 rows, U and V being integers, the light sources being arranged in the display device according to a regular grid with N columns and M rows, N and M being integers, U being a multiple of N, and V being a multiple of M.

In an alternative embodiment, the illumination pattern may be computed at a subsampled resolution with respect to a resolution of the modulator array. The illumination pattern may be computed at the subsampled resolution according to a grid having U+1 columns and V+1 rows, U and V being integers, U being a multiple of a power of two, and V being a multiple of a power of two.

According to another feature, the combination of the contribution of the light sources may be represented by wavelet coefficients, the illumination pattern being computed from an inverse wavelet transform applied to the wavelet coefficients representing said combination.

Another aspect of the invention relates to a method of processing a video signal having video signal frames in a display device having a plurality of light sources arranged to illuminate an illumination area and an array of modulators distributed over the illumination area. The method comprises:
determining respective first control values for the plurality of light sources based on at least one signal frame;
computing an illumination pattern generated by the plurality of light sources as a combination of contributions of said light sources respectively weighted in accordance with the first control values, wherein the contribution of a light source is proportional to a sum of at least:
   a first component, comprising a part of a reference profile aligned on a position of said light source, said part of the aligned reference profile extending within the illumination area; and
   a second component depending on a distance between the position of said light source and an edge of the illumination area;
dividing pixel values of a signal frame by respective values of the illumination pattern corresponding spatially to said pixel values to derive control values for the array of modulators.

Yet another aspect of the invention relates to a display device, comprising:
a plurality of light sources arranged to illuminate an illumination area;
an array of modulators distributed over the illumination area and arranged to control transmission of light received from the light sources to display an image;
a unit for determining respective first control values for the plurality of light sources based on at least one input signal frame;
a computer for estimating an illumination pattern generated by the plurality of light sources as a combination of contributions of said light sources respectively weighted in accordance with the first control values, wherein the contribution of a light source is proportional to a sum of at least:
   a first component, comprising a part of a reference profile aligned on a position of said light source, said part of the aligned reference profile extending within the illumination area; and
   a second component depending on a distance between the position of said light source and an edge of the illumination area;
a frame converter for dividing pixel values of a signal frame by respective values of the illumination pattern corresponding spatially to said pixel values to derive control values for the array of modulators.

Other features and advantages of the method and apparatus disclosed herein will become apparent from the following description of non-limiting embodiments, with reference to the appended drawings.

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1a illustrates a “2D backlight” arrangement in a display panel;

FIG. 1b illustrates an “edge dimming” arrangement in a display panel;

FIG. 2a is a diagram representing examples of individual illumination patterns of LEDs on an edge of a display panel;

FIG. 2b is a diagram representing a global illumination pattern inaccurately estimated from the individual patterns of FIG. 2a;

FIG. 3 is another illustration of an “edge dimming” arrangement in a display panel;

FIG. 4 is a block diagram of a device implementing an embodiment of the invention;

FIG. 5 is a diagram illustrating an example of derivation of the contribution of a light source to the illumination pattern;

FIGS. 6 and 7 are graphs illustrating two different ways of constructing reference profiles for light sources in embodiments of the method.

### DESCRIPTION OF PREFERRED EMBODIMENTS

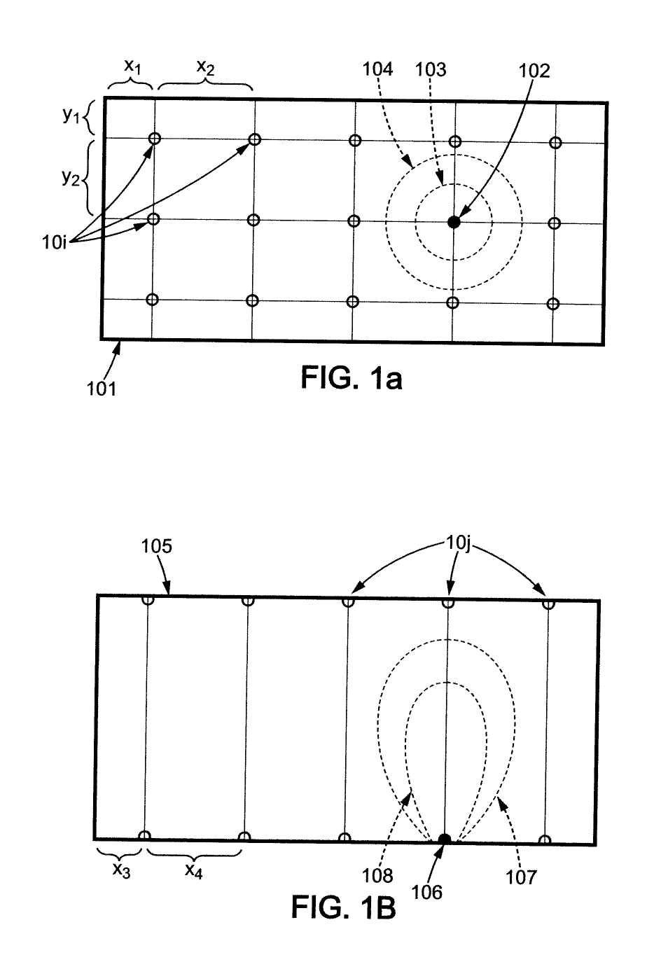

FIGS. 1a and 1b present known arrangements of light sources such as LEDs in a display device. In order to simplify the description, when the word “LED” is mentioned, it does not imply that a simple Light-Emitting Diode is used: a group of them can be used instead. Light sources other than LEDs or LED groups may also be used.

The display panel can be part of a television set, a computer monitor, a pad, a smart-phone, or any other kind of device. It will be observed that the method described here is also applicable to display devices which do not physically have a panel such as, for example, to an overhead projector which may have a light box or similar arrangement providing an illumination area behind an array of light modulators.

The LEDs 10i can be located at the back of the display panel 101 (FIG. 1a). This first arrangement is known as a “2D backlight” arrangement. Alternatively, the LEDs 10j can be arranged along upper and lower edges of the display panel 105 (FIG. 1b). This second arrangement is known as an “edge dimming” arrangement.

The illumination provided by the light sources is managed by respective control signals, e.g. by prescribing different power values to the different LEDs.

In the “2D backlight” arrangement, a LED 102 has a light halo around its spatial position. The light halo has a substantially circular shape since the LEDs illuminate the display panel from the back side, as illustrated by the dashed lines 103 and 104 in FIG. 1a.

A LED 106 provides in the display panel an oval-shaped light halo, as illustrated by the dashed lines 107 and 108 in FIG. 1b.

In most cases, the LEDs are arranged with regular spacing either in the horizontal or vertical direction (in case of “edge dimming” arrangement) or both in horizontal and vertical directions (in case of “2D backlight' arrangement). Moreover, to ensure a homogenous illumination, the LEDs closest to the edge are arranged at a distance to the edge which is about half the spacing between the LEDs on the same line or column. Thus, referring to FIGS. 1a and 1b:
x₁=x₂/2;
y₁=y₂/2;
x₃=x₄/2.

In order to simplify the following description, it is assumed that the display panel has an “edge dimming” arrangement of LEDs. Nevertheless, the person skilled in the art can readily adapt the given examples either to a “2D backlight” arrangement or to any other arrangement.

Each LED provides a specific contribution to the overall illumination of the display panel. For each LED, an individual pattern can be defined, for instance, as the value of the light energy at each point or pixel of the display panel provided by this LED when it is powered with the maximum electrical power while all other LEDs are turned off.

As used herein, the terms “illumination pattern” or simply “pattern” refer to a distribution of light within the illumination area of the display device, while the terms “illumination profile” or simply “profile” refer to a function defined over a spatial domain larger than the illumination area and used to estimate the illumination pattern provided by the plurality of light sources within the illumination area.

The global illumination pattern can be defined as the sum of the individual contributions of the LEDs illuminating the display panel weighted by power factors.

The global illumination pattern, for N LEDs (N being an integer) in the display panel, is then computed as a linear combination of individual LED patterns with weights reflecting the electrical power parameters of each LED, i.e.

$${p}_{G} ( x , y ) = {Σ}_{n} g ( LED ( n ) ) \times p ( x , y ; n )$$

where g(LED(n)) is a function reflecting the intensity of the n^{th} LED as a function of the electrical power parameters (for instance, the input current) specified by LED(n), and n being an integer in [1 . . . N]. In general, g is close to a linear function, but could be slightly nonlinear or with gains and offsets to accurately reflect the current-illumination characteristics of the LED used, and where p(x,y;n) is a value of the individual LED pattern of the n^{th} LED at a position (x, y) of the illumination area.

For simplicity, we assume in the following that g is linear and more particularly that g(x)=x for all x. Moreover, in the example of FIG. 1b, the first to (N/2)^{th} LEDs are considered to be located on the upper edge of the illumination area while the (N/2+1)^{th} to N^{th} LEDs are located on the lower edge.

Consequently, if the display panel is illuminated by 32 LED, it can be needed to store in a memory of the electronic device having the display panel, 32 different individual LED patterns.

If the individual LED patterns are stored in full resolution, the memory space needed can be quite important especially if the display panel is a 1080p panel (1920×1080 pixels).

It is possible to reduce the storage requirements by using down-sampled representations of each individual pattern. By way of example, they can be represented on a sub-sampled grid where x and y are sampled with a step of S=8, 16 or 32, depending on the accuracy sought and the assumed smoothness of the patterns p(x,y;n).

An example is to represent the patterns using sub-sampled arrays: p_{G}(x,y) is then derived from the sub-sampled array p_{G}(u,v) using

$${p}_{G} ( x , y ) = {Σ}_{u , v} {p}_{G} ( u , v ) ϕ ( x - uS , y - vS )$$

where φ is an interpolation function, e.g. bilinear interpolation. More complex interpolation methods can also be used.

Alternatively, individual patterns can be sub-sampled as p(u,v;n)=p(x,y;n) with x=Su and y=Sv with the exceptions that x is 1 when u=0 and y is taken to be 1 when v=0 (instead of 0). It is apparent that S can also be chosen to be different along x and y directions and that it does not need to be a power of 2 or even an integer. If it is not an integer, obviously the computations of p(u,v;n) in the above formula must resort to interpolation. It is however useful in practice when the values U=X/S and V=Y/S (with possibly different values of S for X and Y, X and Y being the vertical and horizontal resolution of the display panel e.g. X=1920 and Y=1080) are integers. So the sub-sampled arrays are defined for values of (u,v) such that 0≦u≦U and 0≦v≦V. If X/S or Y/S are not integers, some values of p(u,v;n) must be computed using interpolation.

The global pattern computation can then be done on a sub-sampled scale with respect to the spatial resolution of the light modulators of the display device.

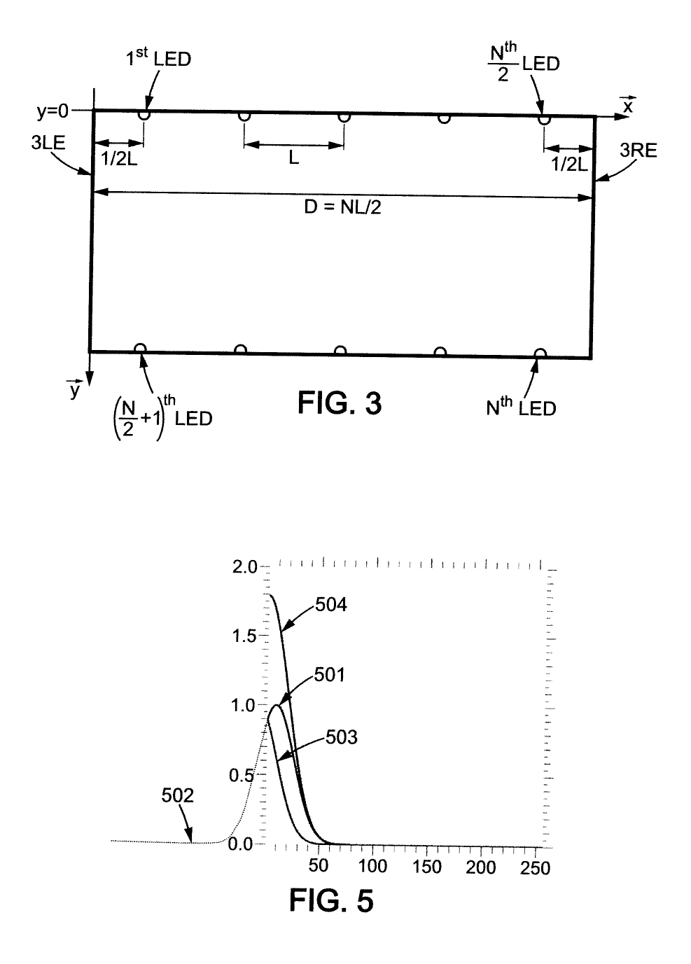

Alternatively or in complement to the sub-sampling, it is possible to represent each of the individual patterns p(u,v;n), for any n, using a translation of a single reference profile f(u,v). Assuming that the distance between adjacent LEDs is L and that the reference profile is aligned on the 1^{st} LED, respective individual illumination patterns can be defined for the LEDs as translates of the reference profile along the horizontal direction as
p(u,v;n)=f(u−(n-1)L, v) for n=1, 2, . . . , N/2 (upper edge)
p(u, v;n)=f (u−(n−N/2−1)L, V−v) for n in N/2+1, N/2+2, . . . , N (lower edge),
   considering that the upper edge of the panel has, as y-coordinate, y=0 as shown in FIG. 3. The lower edge illumination pattern may be considered as a flip of the upper edge illumination pattern.

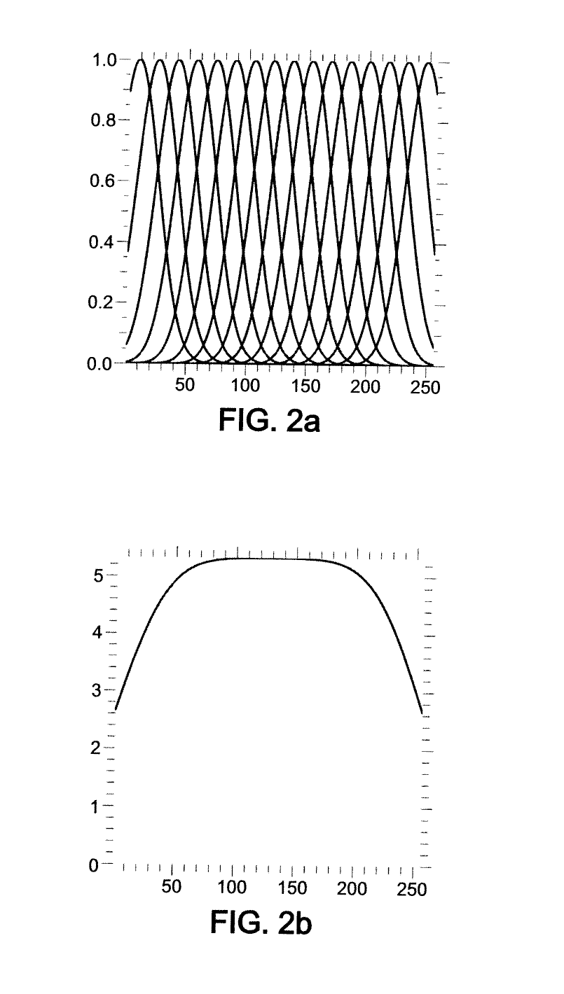

This method does not provide a uniform model for the global illumination pattern when all LEDs are uniformly powered. The modeled global illumination pattern presents attenuation close to the edge of the illumination area, mainly due to the fact that the global pattern is then defined as a finite sum of translates of the reference profile truncated to have the same spatial support as the illumination area. For instance, FIG. 2a presents an example of individual patterns of light sources arranged in a display panel based on a simple translation of a reference profile. When summed, the individual patterns induce a non-even global pattern as shown in FIG. 2b. The resulting approximation is not accurate. It is based on the lo assumption that all individual patterns (or a subset thereof) are identical up to a translation and a truncation. This is particular inaccurate for light sources located close to the panel edges, whose individual patterns cannot be accurately represented as simple translation, because their shape is modified by the light reflection at the panel edges and are thus substantially different from other individual patterns.

As the light reflects at the panel edges, another way to compute the individual patterns uses a “translate and fold” model. The “translate and fold” model consists in generating a pattern by translating a reference profile, i.e. aligning the reference profile with the position of the LED, and folding back part of the translated profile extending beyond an edge of the panel.

The folded part added to the component of the translated reference profile defined on the illumination area may optionally be weighted by a parameter representing the reflectivity of the edge. For instance, if the edge does not reflect all the light emitted by the LED, this parameter may be less than 1. Moreover, the reference profile may be different for one or more subsets of LEDs. For instance, if the LEDs (in the same display device) are from different manufacturers, their associated reference profile may be different.

In order to model the reflection of a LED on the left edge (3LE referring to FIG. 3) it is possible to modify the previous computation of p(u,v;n) by adding a new term f(−u−(n-1)L,v) for the upper edge and f(−u−(n−N/2−1)L, V−v) for the lower edge.

In order to model the reflection of a LED on the right edge (3RE referring to FIG. 3) it is possible to modify the previous computation of p(u,v;n) by adding a new term f(−u−(n-1)L+2D, v) for the upper edge and f(−u−(n−N/2−1)L+2D, V−v) for the lower edge with D=NL/2 being the length of the display panel between the left and right edges.

In FIG. 5 the curve 501 represents the reference profile translated to be aligned on the position of a LED and defined on the illumination area, the curve 503 represents the reflection of the reference profile which goes beyond an edge of the illumination area (see dashed curve 502). In this case, curve 503 is a mirror copy of curve 502 with respect to the edge of the illumination area. Alternatively, it may be slightly different from the mirror copy of curve 502: the mirrored curve may be attenuated, modified, etc. depending on characteristics of the display panel. Curve 504 is obtained by summing the shifted reference profile (curve 501) and the reflection component (curve 503) within the illumination area.

The “translate and fold” model consists in considering that the individual pattern of a LED is the sum of the reference profile translated and truncated at an edge of the illumination area and of a mirror component which depends on the distance between the LED location and an edge of the illumination area. The mirror component may, in particular, be defined as the reflection of the part of the translated profile extending beyond the edge prior to truncation.

This allows generating individual patterns that model with a good approximation the actual illumination patterns of LED, especially near the edges.

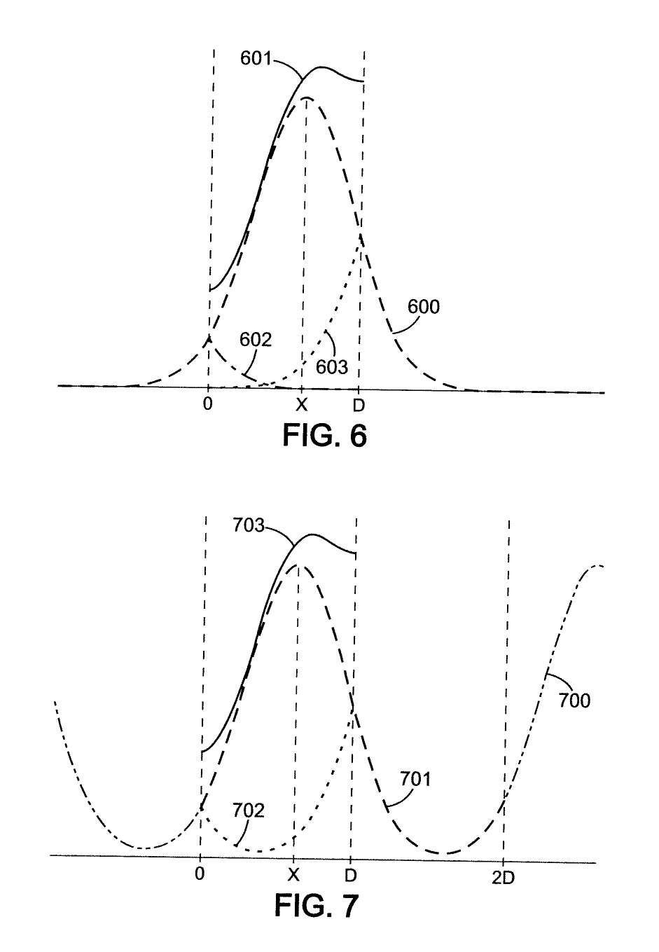

In FIG. 6, the dashed curve 600 represents, by way of non-limiting illustration, what would be the light distribution f(x−X, y₀) provided by an individual light source located at a position X along one dimension of the panel, assuming an infinite extension of the illumination area along that dimension. This curve 600 is for a varying coordinate x along the above-mentioned dimension and a fixed coordinate y₀ along the perpendicular dimension. It is aligned along the x-dimension such that its maximum is located at x=X. The curve 600 for a given y₀ can be assumed to be substantially identical, up to a translation, for all the light sources located at the same coordinate y₁, for example for all LEDs of the upper edge for edge lit arrangement or for all LEDs in a given row for a 2D backlight arrangement, assuming that they have similar characteristics. The set of functions f(x, y₀) for different values of y₀ represents the reference profile in an embodiment of the invention. Due to reflection at the edges, the actual illumination pattern 601 provided by the source, which is defined in the illumination area, i.e. for x ε [0, D}, has further components 602, 603 which are mirror copies of the parts of the shifted reference profile which extend beyond the edges (x=0 and x=D) of the illumination area. The illumination pattern 601 for the source located at x=X can then be modelled by a function h_{X}(x, y₀)=f(x−X, y₀)+f(−x−X, y₀)+f(2D−x−X, y₀). For each sampling point, such an embodiment requires two additions and one multiplication to estimate the illumination pattern of an individual source, and thus 3q-1 additions and q multiplications to obtain the global illumination pattern if there are q sources.

If the curve 600 representing the reference profile has a relatively large extension, it may be necessary to fold it more than once on one or both sides of the illumination area. A more general formula is

$${h}_{X} ( x , {y}_{0} ) = {Σ}_{k} f ( x - X - 2 kD , {y}_{0} ) + {Σ}_{λ} f ( 2 λ D - x - X , {y}_{0} ) ,$$

the ranges for k and l being chosen depending on the support of the illumination profile f(x, y₀) in order to limit complexity while providing reasonable accuracy.

FIG. 7 illustrates an alternative embodiment in which the reference profile f′(x, y₀), represented by curve 700 when shifted to be aligned on the position x=X of a light source, is a periodic function whose period 2D is twice larger than the extension D of the illumination area along the dimension x. Based on the above-mentioned function f(x, y₀), the periodic reference profile f′(x, y₀) can be defined as

$${f}^{′} ( x , {y}_{0} ) = {Σ}_{k} f ( x - 2 kD , {y}_{0} ) .$$

This function f′(x, y₀) can be computed once for all since it does not depend on the position X of the light source, with k in a range as large as desired. The dashed portion 701 of the 700 shown in FIG. 7 represents one period, on the interval domain [0, 2D}, of the function f′(x−X, y₀), i.e. of the reference profile f′(x, y₀) shifted to be aligned on the position x=X of a light source.

In this embodiment, the weighted sum of the shifted illumination profiles can be performed on the domain [0, 2D], namely

$${p}_{1} ( x , {y}_{0} ) = {Σ}_{X} g ( LED ( X ) ) \times {f}^{′} ( x - X , {y}_{0} )$$

for x ε [0, 2D]. Afterwards, the pattern is estimated on [0, D] by folding the values of the accumulated illumination profile p₁(x, y₀) extending beyond the edge x=D of the illumination area into the illumination area (curve 702 in FIG. 7), and by adding the folded values to the accumulated illumination profile, i.e. p_{G}(x, y₀)=p₁(x, y₀)+p₁(2D−x, y₀) for x ε [0, D]. By comparing FIGS. 6 and 7 it can be checked that the individual illumination pattern 601, 703 obtained using both embodiments are the same. The embodiment of FIG. 7 requires 2q-1 additions and q multiplications to obtain the global illumination pattern if there are q sources.

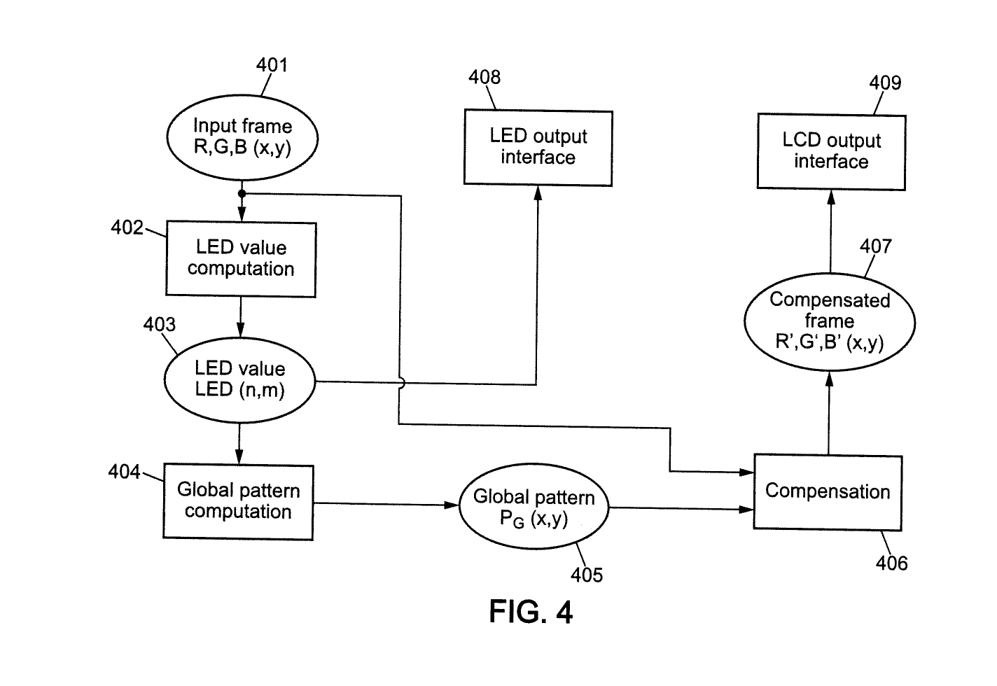

FIG. 4 is a block diagram of a device implementing a method according to the invention.

When receiving an input frame 401 to be displayed, it is possible to interpret it as arrays of RGB triplets, typically each of 8 or 10 bit precision per component. The red component of the input frame at coordinates (x,y) in the display panel is noted hereafter R(x,y) while G(x,y) and B(x,y) respectively denote the green component and the blue component of the input frame at a pixel of coordinates (x,y) in the display panel.

An array of light modulators located in front of the illumination area open and close to allow a set amount of the white light through. For instance, each modulator may be paired with a color filter to remove all but the red, green or blue (RGB) portion of the light from the original white source. The shade of color may be controlled by changing the relative intensity of the light passing through the modulator, i.e. the modulator is arranged to control transmission of light.

A LED value computation unit 402 computes individual LED power values LED(n,m) indicated at 403 in FIG. 4 where the indexes (n,m) represent the position of the LED in a grid on the display panel. For instance, this is a natural indexing for a 2D grid or an edge-lit grid (in the latter case n or m can take only 1 or 2 different values).

The LED power value at coordinates (n, m) can be computed as a function of the RGB triplets of the pixel of the input frame at same coordinates. For instance:

LED(n,m)=max(R(n,m),G(n,m),B(n,m)), or

$$LED ( n , m ) = \frac{( R ( n , m ) + G ( n , m ) + B ( n , m ) )}{3} ,$$

or other weighted combination, or

LED(n,m)=median(R(n,m),G(n,m),B(n,m))

The LED power value at coordinates (n, m) can also be computed as a function of the RGB triplets of the pixels of the input frame at coordinates close to the coordinates (n, m) of the LED. For instance:

LED(n,m)=max( R̅(n,m), G̅(n;m), B̅(n, m))
where X̅((n,m)=agg({X(x,y): x ε Iₙₘ})
where the aggregation function agg of a set of values is either an average, or a maximum or some percentile of the set of input values, or another aggregation function based on the distribution of the input values
where the index set Iₙₘ contains pairs of indexes (x,y) of pixels that are close to the LED group (n,m).
   It is apparent that the aggregation function can be replaced by more complex functions that take into account the relative positions of pixels that are close to the LED group (n,m) with respect to the position of the said group.

If the input values R(x,y), G(x,y) and B(x,y) in the input frame 401 are not linear values reflecting luminance, (for example the values are in the classical 8 or 10 bit representation in a sRGB or standard RGB color space), an appropriate gamma transform can be made to compute linear values, approximately amounting to computing the γ power of the sRGB values, where γ=2.2.

The goal of the LED value computation is to enhance the image rendering by the display panel. By reducing on different points of the display panel the LED illumination, the contrast of the image can be rendered more efficiently and the black regions of the frame input can be deeper and darker. It also allows to significantly reduce power consumption of the display panel, while reconstructing similar or better image.

Once computation of the LED values has been performed in unit 402, the LED groups of the display panel are controlled by adjusting the current/power delivered to them through a LED output interface 408.

The input frame 401 can be compensated in order to take into account the inhomogeneous illumination of the display panel. If the illumination is to be reduced at a pixel of the display panel, the values of the RGB triplets should be locally increased in order to display the expected image. It can be observed that a pixel of color “dark red”, for instance, illuminated with a given amount of light appears (to a human eye) identical to a pixel of color “light red”, illuminated with fewer light.

A compensation unit 406 is provided to adapt accurately the input frame 401. In an embodiment, the global pattern is estimated as detailed above by a computation unit 404, with a “translate and fold” model.

After computation by the unit 404 of a global illumination pattern p_{G}(x, y) (405 in FIG. 4) which is an estimate of the actual illumination pattern of the backlight resulting from setting the power of each individual LED of the backlight panel to LED(n,m), the unit 406 performs the compensation of the RGB triplets of the input frame 401.

The compensation unit 406 takes in input the values of the input frame 401 and computes R′, G′ and B′ values (new compensated RGB components) by computing, for instance,

$${R}^{′} ( x , y ) = \frac{R ( x , y )}{{p}_{G} ( x , y )}$$

(and likewise for G′ and B′) for a pixel at coordinates (x,y).

The values might have to be clipped or otherwise modified so that they stay in their allowable range, if the result of the division takes said values outside of their allowable range. This computation can also be implemented with look-up tables and with a multiplier to simplify the electronic implementation.

The LED values 403 and the compensated frame 407 are then sent through their respective output interfaces 408 and 409 to the LED backlit LCD panel (or other applicable type of the display panel).

It is apparent that the compensation stage can be performed on linear or nonlinear (gamma compensated) values, using proper gamma correction stages in the pipeline. It is usually useful to switch back and forth to/from gamma compensated values if the bit depth of intermediate values is important in terms of bandwidth or storage space, because the necessary quantization is more perceptually uniform in gamma compensated values and thus less susceptible to cause visible quantization artefacts in the display system for an identical bit depth.

However, the computation in unit 404 of the global illumination pattern is performed on linear coordinates, because this block is supposed to compute an estimate of the actual illumination pattern, and the most correct model adds illumination patterns measured in linear (non gamma compensated) values.

As described above, the computation of the global pattern can be based on the use of a single reference profile f(u,v) to determine all individual patterns p(u,v;n) with a “translate and fold” model.

It is advantageous to further reduce the storage requirement for the reference profile and further reduce the amount of computations involved in the computation of the subsampled global illumination pattern

$${p}_{G} ( u , v ) = {Σ}_{n , m} LED ( n , m ) \times p ( u , v ; n , m )$$

with (n,m) defining position of a LED (for example, for a 2D grid, with 0<n≦N, 0<m≦M and N, M integers equal to the number of LEDs in a row and in a column, respectively) and (u,v) coordinates on the display panel with respect to the subsampled coordinate system.

As detailed above, it is proposed to subsample the global pattern and the reference profile. Thus, the values of the illumination pattern can be represented by matrices [0 . . . U]×[0 . . . V] with U and V positive integers.

In a preferred embodiment, and in order to be able to fold the individual patterns, the reference profile has a support length twice the dimension of the display panel. Thus, instead of having a number of samples of the reference profile equal to (U+1)×(V+1) (dimension of the subsampled matrix), the profile has twice the number of samples (for edge dimming : dimensions multiplied by two along the x-axis) or four times the number of samples (for 2D backlight: dimensions multiplied by two along the x-axis and the y-axis). It can be shown that in the case of edge reflections with reflection coefficient equal to one, a periodic reference profile defined over such support is sufficient to accurately and fully describe a reference profile representing a single light source defined over support of any size.

Then, in order to compute the global patterns p_{G}, about (N×M)×5×(U+1)×(V+1) multiply operations and add operations have to be computed (for 2D backlight).

In the present invention, we may use a truncated wavelet transform of the reference profile to perform the computations instead of a flat sampling of the pattern. The truncated wavelet transform of the reference profile consists for instance in keeping only wavelet coefficients that are above a given and/or predefined threshold.

If the wavelet transform is done with a number of scales j along the directions \vec{u} and \vec{v} such that the coarse scale grid is of size

$$\frac{U}{{2}^{j}}$$

along \vec{u} and

$$\frac{V}{{2}^{j}}$$

along \vec{v} (with j an integer) and the coarse grid sizes are still multiples of N and M, i.e.

$$\frac{U}{{2}^{j}} = {k}_{1} N and \frac{V}{{2}^{j}} = {k}_{2} M ,$$

then the wavelet coefficients of the translated reference profile can be derived from the wavelet coefficients of the reference profile. In an embodiment, k₁ and/or k₂ may be equal to 1.

In addition, if the wavelet filters used in the decomposition are symmetric (or anti-symmetric), the wavelet coefficients of reflections of the translated reference profile can be derived from the wavelet coefficients of the translated reference profile. The wavelet coefficients of said reflections can be added to the corresponding wavelet coefficients of the translated reference profile in order to calculate the wavelet coefficients of an individual illumination pattern.

Furthermore, the wavelet coefficients of different individual illumination patterns can be added to each other in order to calculate the wavelet coefficients of the global illumination pattern. An inverse wavelet transform can then be applied to the said wavelet coefficients in order to return to the flat sampling of the global illumination pattern.

In practice, the reference profile is mostly regular. This means that when approximating the profile with a truncated wavelet coefficient representation, the resulting approximated profile will still accurately represent the original profile with few coefficients (for instance 5% of them). This means that for each computation step, the number of multiply and add operations is lowered by 95%, which is a substantial saving of computation time. The storage required to store the profile is also reduced by a similar amount.

In the case of edge dimming, the main constraint is that the number of scales of the wavelet transform along the u direction is such that

$$\frac{U}{{2}^{j}}$$

is a multiple of N.

This wavelet decomposition can be extended to other geometries or other temporal sequences of images in addition to the cases of 2D LED arrays and simple top/bottom, left/right edge or single-edge dimming, such as, for example, the segmented backlight frames as described in U.S. Pat. No. 7,800,708. If the panel backlight frame is simply split with an additional reflective surface parallel to the top and bottom edges, then the panel can be seen as combination of two panels, one with an array of light sources located at the top, and one with an array of light sources located at the bottom.

Both embodiments of FIGS. 6 and 7 can be adapted to make use of a wavelet representation of the illumination profiles and/or of an interpolation scheme as explained above.

A person skilled in the art will readily appreciate that various parameters disclosed in the description may be modified and that various embodiments disclosed may be combined without departing from the scope of the invention.

For example, the above description and figures can be generalized in order to take the time as a parameter. For instance, the input frame 401 can depend on a time parameter (for instance for a video stream). The computation of a global pattern p_{G}(t;x,y) (405) at time t can use LED values at time (t-1), i.e. LED(t-1;n,m) (403) obtained from the previous frame of the frame, in order to reduce latency or external storage requirements. Similarly, the computation of the LED values (403) at time t can take into account LED values (403) at one or several previous moments of time (t-k) with k>1, in order to achieve particular temporal properties of the backlight compensation pattern, for example, smooth transitions between significantly different compensation patterns.

In addition, the LED in the illumination area may be arranged in many other arrangements. For instance, some illumination area may have quite irregular 2D backlight arrangements, not in a grid.

1. A method of estimating an illumination pattern in a display device having a plurality of light sources arranged to illuminate an illumination area and an array of modulators distributed over the illumination area, the light sources being driven by respective control signals to generate the illumination pattern, the modulators being arranged to control transmission of light received from the light sources to display an image, the method comprising computing the illumination pattern generated by the plurality of light sources as a combination of contributions of said light sources, wherein the contribution of a light source is proportional to a sum of at least:
a first component, comprising a part of a reference profile aligned on a position of said light source, said part of the aligned reference profile extending within the illumination area; and
a second component depending on a distance between the position of said light source and an edge of the illumination area.

2. The method of claim 1, wherein the second component is proportional to a mirror copy, with respect to said edge of the illumination area, of another part of the reference profile aligned on the position of said light source, said other part of the aligned reference profile extending beyond said edge of the illumination area.

3. The method of claim 1, wherein said sum includes:
said first component;
said second component depending on the distance between the position of the light source and a first edge of the illumination area; and
a third component depending on a distance between the position of the light source and a second edge of the illumination area, opposite said first edge.

4. The method of claim 3, wherein the second component is proportional to a mirror copy, with respect to the first edge of the illumination area, of a second part of the reference profile aligned on the position of the light source, said second part of the aligned reference profile extending beyond the first edge of the illumination area, and wherein the third component is proportional to a minor copy, with respect to the second edge of the illumination area, of a third part of the reference profile aligned on the position of the light source, said third part of the aligned reference profile extending beyond the second edge of the illumination area.

5. The method of claim 1, wherein the reference profile is periodic along at least one dimension of the illumination area, with a period twice larger than an extension of the illumination area along said dimension.

6. The method of claim 5, wherein computing the illumination pattern generated by the plurality of light sources comprises:
for each light source, shifting the periodic reference profile into alignment with said light source;
within a domain having an extension twice larger than the extension of the illumination area along said dimension, summing weighted values of the respective shifted reference profiles for the plurality of light sources to obtain an accumulated illumination profile defined in said domain; and
folding values of the accumulated illumination profile extending beyond an edge of the illumination area into the illumination area and, in the illumination area, adding the accumulated illumination profile and the folded accumulated illumination profile.

7. The method of claim 1, wherein wavelet coefficients are stored to represent the reference profile.

8. The method of claim 7, wherein the wavelet coefficients are derived from the reference profile using symmetric or asymmetric wavelet filters.

9. The method of claim 8, wherein the derivation of the wavelet coefficients comprises a truncation of wavelet coefficients.

10. The method of claim 1, wherein the illumination pattern is computed at a subsampled resolution with respect to a resolution of the modulator array.

11. The method of claim 10, wherein the illumination pattern is computed at the subsampled resolution according to a grid having U+1 columns and V+1 rows, U and V being integers, and wherein the light sources are arranged in the display device according to a regular grid with N columns and M rows, N and M being integers, U being a multiple of N, and V being and a multiple of M.

12. The method of claim 10, wherein the illumination pattern is computed at the subsampled resolution according to a grid having U+1 columns and V+1 rows, U and V being integers, U being a multiple of a power of two, and V being a multiple of a power of two.

13. The method of claim 7, wherein the contributions of said light sources and the combination of the said contributions are represented by wavelet coefficients, the illumination pattern being computed from an inverse wavelet transform applied to the wavelet coefficients representing said combination.

14. A method of processing a video signal having video signal frames in a display device having a plurality of light sources arranged to illuminate an illumination area and an array of modulators distributed over the illumination area, the modulators being arranged to control transmission of light received from the light sources to display an image, the method comprising:
determining respective first control values for the plurality of light sources based on at least one signal frame;
computing an illumination pattern generated by the plurality of light sources as a combination of contributions of said light sources respectively weighted in accordance with the first control values, wherein the contribution of a light source is proportional to a sum of at least:
a first component, comprising a part of a reference profile aligned on a position of said light source, said part of the aligned reference profile extending within the illumination area; and
a second component depending on a distance between the position of said light source and an edge of the illumination area;
dividing pixel values of a signal frame by respective values of the illumination pattern corresponding spatially to said pixel values to derive control values for the array of modulators.

15. The method of claim 14, wherein the second component is proportional to a mirror copy, with respect to said edge of the illumination area, of another part of the reference profile aligned on the position of said light source, said other part of the aligned reference profile extending beyond said edge of the illumination area.

16. The method of claim 14, wherein the reference profile is periodic along at least one dimension of the illumination area, with a period twice larger than an extension of the illumination area along said dimension.

17. A display device, comprising:
a plurality of light sources arranged to illuminate an illumination area;
an array of modulators distributed over the illumination area and arranged to control transmission of light received from the light sources to display an image;
a unit for determining respective first control values for the plurality of light sources based on at least one input signal frame;
a computer for estimating an illumination pattern generated by the plurality of light sources as a combination of contributions of said light sources respectively weighted in accordance with the first control values, wherein the contribution of a light source is proportional to a sum of at least:
a first component, comprising a part of a reference profile aligned on a position of said light source, said part of the aligned reference profile extending within the illumination area; and
a second component depending on a distance between the position of said light source and an edge of the illumination area;
a frame converter for dividing pixel values of a signal frame by respective values of the illumination pattern corresponding spatially to said pixel values to derive control values for the array of modulators.
